(19) United States
(12) Patent Application Publication
(10) Pub. No.: US 2020/0162964 A1
(43) Pub. Date: May 21, 2020

(54) SIGNALING OF ENCODING SCHEMES IN PACKETS TRANSMITTED OVER A WLAN

(71) Applicant: Marvell World Trade Ltd., St. Michael (BB)

(72) Inventors: Sudhir Srinivasa, Los Gatos, CA (US); Hongyuan Zhang, Fremont, CA (US); Yan Zhang, Palo Alto, CA (US); Rui Cao, Fremont, CA (US); Liwen Chu, San Ramon, CA (US)

(21) Appl. No.: 16/687,717

(22) Filed: Nov. 19, 2019

Related U.S. Application Data
(60) Provisional application No. 62/770,086, filed on Nov. 20, 2018.

(51) Int. Cl. H04W 28/06; H04L 1/00; H04L 1/18

(52) U.S. Cl. CPC H04W 28/065; H04L 1/0041; H04W 84/12; H04L 1/18; H04L 1/0045

(57) ABSTRACT

A method for data transmission in a wireless local area network (WLAN). The method includes receiving, in a physical layer (PHY) interface of a first node in the WLAN, data for transmission over the WLAN. The received data are divided in the PHY interface into a sequence of data blocks having respective lengths, and encoding the data blocks using an error correcting code (ECC). The encoded data blocks are encapsulated in a PHY protocol data unit (PPDU) together with encoding metadata including at least an indication of the respective lengths of the data blocks. The PPDU is transmitted over the WLAN from the first node to a second node in the WLAN.

### CROSS-REFERENCE TO RELATED APPLICATION

This application claims the benefit of U.S. Provisional Patent Application 62/770,086, filed Nov. 20, 2018, which is incorporated herein by reference.

### FIELD OF THE INVENTION

The present invention relates generally to methods and apparatus for wireless communications, and particularly to encoding of data for transmission over a wireless local area network (WLAN).

### BACKGROUND

In WLANs operating in accordance with IEEE 802.11 (Wi-Fi) standards, the medium access control (MAC) interface of a transmitter, such as an access point (AP) or client station (STA), encapsulates data in MAC-layer frames known as MAC protocol data units (MPDUs). Each MPDU includes a MAC header and a frame check sequence (FCS) for purposes of error detection. For efficient use of transmission and processing resources, multiple MPDUs may be joined together into a single aggregated MPDU (A-MDPU) for transmission to the receiver. The physical layer (PHY) interface of the transmitter divides the bits of the MPDU (or A-MPDU) into blocks, encodes each block using an error correction code (ECC), and maps the bits to data symbols. Groups of these data symbols are encapsulated in packets known as PHY protocol data units (PPDUs), in which the data symbols are preceded by a PHY header, commonly referred to as a preamble, and are then modulated onto a radio frequency (RF) carrier for transmission over the wireless interface to the receiver.

The PHY interface of the receiver demodulates and decodes the PPDUs that it receives, including correction of bit errors using the ECC, and passes the data to the MAC interface, which reconstructs and processes the MPDUs to extract the transmitted data. When an MPDU is corrupted in transit, the MAC interface of the receiver may return a retransmission request for the MPDU in question to the MAC interface of the transmitter. When data are grouped into A-MPDUs, the receiver may request retransmission of only the specific MPDU that was found to be corrupted. The transmitter will then re-encode the requested MPDU in a new PPDU for transmission to the receiver. The retransmission process is handled at the MAC layer, and the PHY layer does not typically distinguish between original and retransmitted data.

### SUMMARY

Embodiments of the present invention that are described hereinbelow provide improved methods for encoding of data blocks for transmission over a network, as well as apparatus and systems that implement such methods.

There is therefore provided, in accordance with an embodiment of the invention, a method for data transmission in a wireless local area network (WLAN). The method includes receiving, in a physical layer (PHY) interface of a first node in the WLAN, data for transmission over the WLAN. The received data are divided in the PHY interface into a sequence of data blocks having respective lengths, and encoding the data blocks using an error correcting code (ECC). The encoded data blocks are encapsulated in a PHY protocol data unit (PPDU) together with encoding metadata including at least an indication of the respective lengths of the data blocks. The PPDU is transmitted over the WLAN from the first node to a second node in the WLAN.

In a disclosed embodiment, encapsulating the encoded data blocks includes incorporating the encoding metadata in a preamble of the PPDU. Alternatively or additionally, encapsulating the encoded data blocks includes attaching respective block headers containing the encoding metadata to the data blocks in the PPDU.

In the disclosed embodiments, the indication of the respective lengths includes a number of data units selected from a group of data units consisting of a bits, bytes, symbols, time units, and codewords. Additionally or alternatively, the encoding metadata further include one or more encoding parameters, selected from a group of parameters consisting of a coding rate and a codeword length.

In one embodiment, receiving in the PHY interface from the second node an automatic retransmission request (ARQ) over the WLAN to retransmit one of the encoded data blocks, and retransmitting the one of the encoded data blocks from the PHY interface using the encoding metadata.

In another embodiment, transmitting the PPDU includes transmitting the encoded data blocks together with the encoding metadata from the first node to the second node over two different frequency channels in the WLAN.

There is also provided, in accordance with an embodiment of the invention, a method for data reception in a wireless local area network (WLAN). The method includes receiving over the WLAN, in a physical layer (PHY) interface of a second node in the WLAN, a PHY protocol data unit (PPDU) transmitted by a first node in the WLAN, the PPDU including a sequence of data blocks, which have respective lengths, and are encoded using an error correcting code (ECC), together with encoding metadata including at least an indication of the respective lengths of the data blocks. The data blocks are decoded in a second PHY interface of the second node to recover the data using the encoding metadata.

In one embodiment, decoding the data blocks includes detecting at the second node that the PHY interface is unable to decode one of the encoded data blocks in the PPDU using the ECC, and transmitting an automatic retransmission request (ARQ) from the PHY interface to the first node over the WLAN to retransmit the one of the encoded data blocks using the encoding metadata.

In another embodiment, receiving the PPDU includes receiving the encoded data blocks together with the encoding metadata from the first node at the second node over two different frequency channels in the WLAN, and decoding the data blocks includes jointly decoding the encoded data blocks received from the two different frequency channels using the encoding metadata.

There is additionally provided, in accordance with an embodiment of the invention, apparatus for data transmission in a wireless local area network (WLAN). The apparatus includes a medium access control (MAC) interface, which is configured to generate frames of data for transmission over the WLAN. A physical layer (PHY) interface is coupled to receive the data from the MAC interface and configured to divide the received data into a sequence of data blocks having respective lengths, encode the data blocks using an error correcting code (ECC), encapsulate the encoded data blocks in a PHY protocol data unit (PPDU) together with encoding metadata including at least an indication of the respective lengths of the data blocks, and transmit the PPDU over the WLAN to a receiving node in the WLAN.

There is further provided, in accordance with an embodiment of the invention, a WLAN system including the apparatus for data transmission described above, including a first MAC interface and a first PHY interface. The receiving node includes a second PHY interface configured to receive the PPDU over the WLAN from the transmitting node and to decode the data blocks using the encoding metadata to recover the data.

The present invention will be more fully understood from the following detailed description of the embodiments thereof, taken together with the drawings in which:

### BRIEF DESCRIPTION OF THE DRAWINGS

FIG. 1 is schematic pictorial illustration of a wireless network system, in accordance with an embodiment of the invention;

FIG. 2 is a block diagram that schematically illustrates transmit-side PHY circuitry of a WLAN device in the system of FIG. 1, in accordance with an embodiment of the invention;

FIG. 3 is a block diagram that schematically illustrates successive stages in encoding and transmission of data over a WLAN, in accordance with an embodiment of the invention;

FIG. 4 is a block diagram that schematically illustrates receive-side PHY circuitry of a WLAN device in the system of FIG. 1, in accordance with an embodiment of the invention.

### DETAILED DESCRIPTION OF EMBODIMENTS

As explained above, in Wi-Fi networks that are known in the art, the PHY interface of the transmitter receives data from the MAC interface and divides the data into a sequence of data blocks for transmission to the intended receiver. The PHY interface encodes the bits in each such block using an ECC. Existing Wi-Fi standards, such as the IEEE 802.11ax standard, support a variety of different encoding schemes, including both binary convolutional coding (BCC) and low-density parity check (LDPC), which can be applied to blocks of various lengths. The PHY interface of the receiver applies the appropriate decoding scheme and parameters to decode each block, and then passes the decoded data to the MAC interface for further processing (including MAC-level retransmission requests when required). There is no need, in compliance with the existing Wi-Fi standards, for the transmitter and receiver to keep track of or coordinate block boundaries at the PHY level.

Emerging Wi-Fi standards, however, such as IEEE 802.11be with Extremely High Throughput (EHT), are expected to offer enhanced PHY capabilities relative to existing standards, for example enabling HARQ, as well as multi-band operation and channel aggregation. To support these capabilities, it is desirable that each block be identifiable at the PHY interfaces of both the transmitter and the receiver through a unique index. Assuming block lengths to be variable, as in existing Wi-Fi standards, the length of each block in any given PPDU should also be known to both the transmitter and the receiver. Using this information, the receiver can then detect the block boundaries in the received PPDUs unambiguously and decode the blocks accordingly.

In particular, the receiver and the transmitter can use the block identifications for efficiently implementing hybrid automatic repeat request (HARQ) functionality. In HARQ, the PHY interface of the transmitter encodes data with an ECC, which the PHY interface of the receiver uses in correcting small numbers of bit errors. When the PHY interface of the receiver is unable to correct all the errors in a given data block, it requests a retransmission of that data block. The block identifications provided by the present embodiments are useful in HARQ, since the blocks to be retransmitted will be identified precisely in the retransmission requests. The receiver will also be able to use the block identifications when jointly decoding multiple transmissions of the same block, which it may receive in a HARQ response or over different bands of a multi-band link.

In response to this need for block-level coordination between the PHY interfaces of the Wi-Fi transmitter and receiver, embodiments of the present invention that are described herein provide a transmitting PHY interface that encapsulates encoding metadata together with the encoded data blocks in each PPDU, so as the enable the receiving PHY interface to identify the block boundaries. Typically, the encoding metadata include an index for each block. To maintain compatibility with the flexible encoding schemes offered by existing Wi-Fi standards, the encoding metadata can also include other encoding parameters, including at least an indication of the respective lengths of the data blocks in the PPDU, and possibly also the coding rate and/or codeword length. The lengths of the data blocks can be expressed in any appropriate sort of data units, such as bits, bytes, symbols, time units required for transmission, or codewords of encoded data.

The PHY interface of the transmitter can insert the encoding metadata in any suitable location within the PPDUs. For example, in some embodiments, the encoding metadata are incorporated in the preambles of the PPDUs, for instance in a signaling (SIG) field of the preamble. Alternatively or additionally, the PHY interface of the transmitter attaches to each data block a block header containing the encoding metadata for that block. These encapsulation schemes are advantageous, inter alia, in enabling the encoding and decoding hardware that was developed for existing standards, such as IEEE 802.11ax, to be adapted for use in devices that support more advanced standards, such as IEEE 802.11be, with only minimal changes to the hardware and minimal additional transmission overhead in the PPDU. As a further alternative, at least some of the encoding metadata may be conveyed between the transmitter and receiver in a separate signaling exchange or in a higher protocol layer, for example in the MAC-layer data or headers.

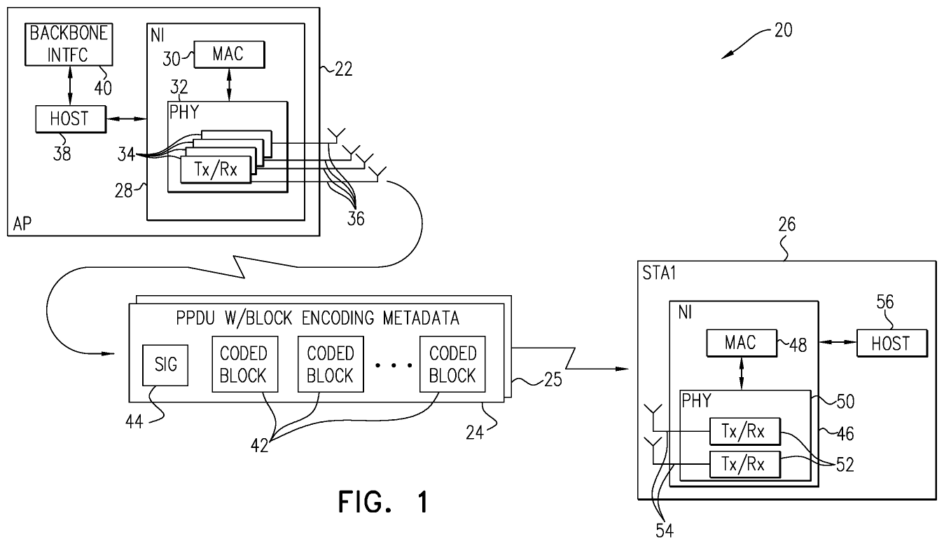

FIG. 1 is schematic pictorial illustration of a wireless local area network (WLAN) system 20, in accordance with an embodiment of the invention. In system 20, an access point (AP) 22 transmits a data packet, referred to as a PPDU 24, over a wireless interface to a client station (STA) 26, with encoding metadata encapsulated in the PPDU as noted above. A similar scheme is typically used in uplink transmissions from STA 26 to AP 22.

AP 22 comprises a network interface (NI) 28, which comprises PHY and MAC interfaces 30 and 32, typically in accordance with applicable IEEE 802.11 specifications, with the addition of specific features relating to PHY-level encoding metadata as described herein. PHY interface 32 comprises multiple radio transceivers 34, which are connected to antennas 36. In the pictured embodiment, PHY interface 32 comprises four such transceivers, each with its own antenna. Alternatively, larger or smaller numbers of transceivers and antennas may be used, with one or more antennas connected to each transceiver. Transceivers 34 may all operate in the same frequency band, or they may transmit and receive on different, respective frequency bands. In general, the components of PHY and MAC interfaces 30 and 32 are implemented in dedicated or programmable hardware logic circuits, on a single integrated circuit chip or a set of two or more chips, which may be packaged as a single module.

A host processor 38 passes data to network interface 28 for transmission over the wireless interface to target receivers, such as STA 26, and also receives incoming data from network interface 28. In addition, host processor 38 communicates over a backbone network via a backbone interface 40, such as an Ethernet interface, a WLAN interface, or a mesh network interface. Host processor 38 suitably comprises a programmable processor, along with a suitable memory and other resources (not shown), and is programmed in software or firmware to carry out various control and communication functions in AP 22. The software run by host processor 60 is suitably stored in tangible, non-transitory computer-readable media, such as a suitable RAM or ROM memory in various embodiments. Host processor 38 may be implemented together with the elements of network interface 28 and backbone interface 40 in a single system-on-chip (SoC), or as a separate chip or chip set.

In typical operation, host processor 38 passes data for transmission over the WLAN to MAC interface 30, which frames the data in MPDUs and passes the MPDUs to PHY interface 32. The PHY interface divides the received data into a sequence of data blocks and encodes the data blocks using an error correcting code (ECC), such as a BCC or LDPC, thus generating coded blocks 42, which it encapsulates in PPDU 24. Blocks 42 in a given PPDU may all be of the same length, or they may have different, respective lengths. To inform STA 26 of the block indexes, lengths, and possibly other encoding parameters, PHY interface 32 inserts encoding metadata, including at least an indication of the respective lengths of blocks 42 into PPDU 24. In accordance with an embodiment, the encoding metadata is encapsulated in a signaling field 44, which is a part of the preamble of PPDU 24, as shown in FIG. 1. Alternatively or additionally, the encoding metadata are distributed at other locations in the PPDU, such as in respective headers (not shown) of blocks 42.

STA 26 likewise comprises a network interface (NI) 46, which comprises PHY and MAC interfaces 50 and 48, similar to interfaces 30 and 32 in AP 22. PHY interface 50 comprises one or more radio transceivers 52, which are connected to antennas 54. In the pictured embodiment, PHY interface 50 comprises two such transceivers, each with its own antenna. Alternatively, larger or smaller numbers of transceivers and antennas may be used, with one or more antennas connected to each transceiver. In general, the components of PHY and MAC interfaces 50 and 48 are implemented in dedicated or programmable hardware logic circuits, on a single integrated circuit chip or a set of two or more chips.

A host processor 56 passes data to network interface 46 for transmission over the wireless interface to target AP receivers, and receives incoming data from network interface 46. Host processor 50 typically comprises a microprocessor, along with a suitable memory and other resources (not shown), and is programmed in software or firmware to carry out various control and communication functions in STA 26. The software may be stored in tangible, non-transitory computer-readable media, such as a suitable RAM or ROM memory. Host processor 56 may be implemented together with the elements of network interface 46 in a single system-on-chip (SoC), or as a separate chip or chip set.

Upon receiving PPDU 24 from AP 22, PHY interface 50 in STA 26 uses the encoding metadata encapsulated in the PPDU (for example in signaling field 44) in decoding blocks 42 and thus recovering the transmitted data. PHY interface 50 passes the decoded data stream to MAC interface 48 for MAC-level processing (which is beyond the scope of the present description).

In some embodiments, PHY interfaces 32 and 50 implement HARQ functionality. In this case, when PHY interface 50 is unable to decode one of encoded data blocks 42 in PPDU 24 using the ECC incorporated in the block, PHY interface 50 transmits an automatic retransmission request (ARQ) over the WLAN to PHY interface 32 in AP 22. The ARQ specifies the block index of the data block that is to be retransmitted. PHY interface 32 will read the requested data block from a buffer in AP 22, and will then re-encode and retransmit the requested data block to STA 26 using the same encoding metadata as in the original transmission.

Additionally or alternatively, in some embodiments PHY interface 32 in AP 22 transmits encoded data blocks 42 together with the encoding metadata to STA 26 over two different frequency channels in the WLAN, for example by transmitting PPDU 24 and another PPDU 25 via two (or more) different transceivers 34, which are tuned to transmit in different frequency bands. PHY interface 50 in STA 26 will receive data blocks 42 on the different frequency channels via transceivers 52. It will then jointly decode the encoded data blocks received from the two different frequency channels using the corresponding block indexes and other encoding metadata.

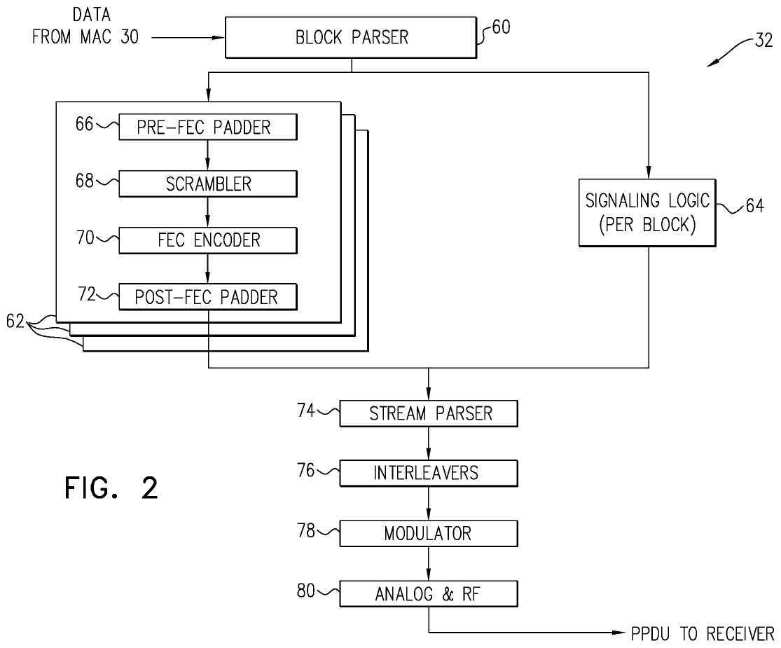

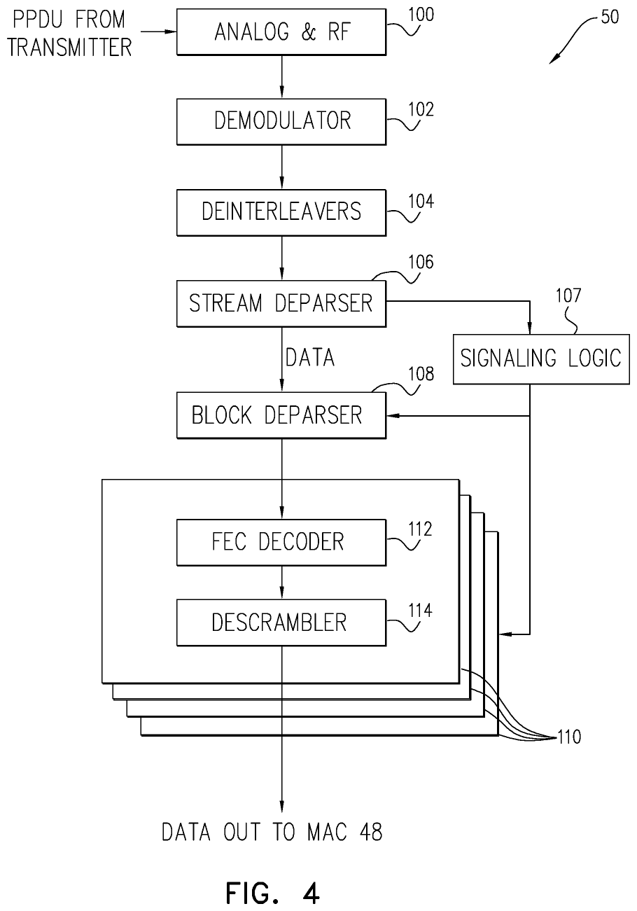

The configurations of system 20 and of AP 22 and STA 26 shown in FIG. 1, as well as their components, such as the elements of AP PHY interface 32 shown in FIG. 2 and the elements of STA PHY interface 50 shown in FIG. 4, are shown and described here solely by way of example. In alternative embodiments, any other suitable configurations can be used. The various elements of AP 22 and STA 26 may be implemented using dedicated hardware or firmware, such as hard-wired or programmable components, for example in one or more Application-Specific Integrated Circuits (ASICs), Field-Programmable Gate Arrays (FPGAs) or RF Integrated Circuits (RFICs), using software, or using a combination of hardware and software elements.

In some embodiments, certain elements of AP 22 and/or STA 26, for example certain functions of network interfaces 28 and 46, are implemented in one or more programmable processors, which are programmed in software to carry out the functions described herein. The software may be downloaded to the one or more processors in electronic form, over a network, for example, or it may, alternatively or additionally, be provided and/or stored on non-transitory tangible media, such as magnetic, optical, or electronic memory.

FIG. 2 is a block diagram that schematically illustrates transmit-side circuitry in PHY interface 32, in accordance with an embodiment of the invention. PHY interface 32 comprises a pipeline of the following modules:
A block parser 60 divides the incoming data stream from MAC interface 30 into a sequence of data blocks. Each block is assigned a respective index, as well as other metadata such as the block length and encoding scheme that is to be applied to the block.
A respective block encoder 62 performs forward error correction (FEC) encoding by applying the designated ECC to each of the data blocks. Block encoder 62 includes the following functional modules:
   A pre-FEC padder 64 pads the input data of original transmissions in preparation for FEC encoding.
   A scrambler 68 scrambles the padded data by bit-wise multiplication with a scrambling sequence.
   A FEC encoder 70 encodes the data with the designated ECC, such as a BCC or LDPC. Alternatively, any other suitable type of FEC can be used.
   A post-FEC padder 72 pads the encoded data produced by FEC encoder 70 to reach the desired size of coded block 42.
Signaling logic 64 receives the encoding metadata for each block and frames the metadata for insertion in the appropriate field or fields within PPDU 24, for example in signaling field 44 or in headers of blocks 42, as explained above.
A stream parser 74 separates the encoded data and metadata into spatial streams.
Interleavers 76 (typically one per spatial stream) interleave the data within each stream.
A modulator 78 maps the interleaved data in each spatial stream onto constellation symbols, for example a constellation of quadrature amplitude modulation (QAM) symbols. The constellation mapping is followed by other modulation functions that are known in the art, including spatial multiplexing (beamforming) of the spatial streams, transformation of the spatially-multiplexed signal to the time domain, and windowing for spectral shaping of the signal. Assuming PHY interface 32 implements an orthogonal frequency domain multiplexing (OFDM) scheme, as specified by the IEEE 802.11ax standard, for example, modulator 78 outputs a modulated digital signal comprising a sequence of OFDM symbols, each covering multiple tones and spatial streams.
Analog & RF modules 80 (typically embodied in transceivers 34) convert the modulated digital signal into an analog radio frequency (RF) signal, for transmission by antennas 36.

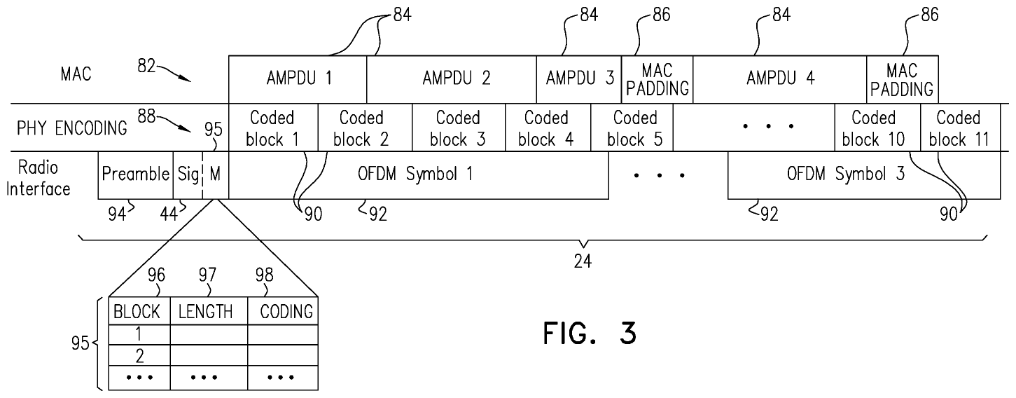

FIG. 3 is a block diagram that schematically illustrates sequential stages in encoding and transmission of PPDU 24 by MAC interface 30 and PHY interface 32, in accordance with an embodiment of the invention. MAC interface 30 generates a stream 82 of data comprising a sequence of A-MPDUs 84, containing MAC headers and payload data, with MAC padding 86 added as necessary to fill in gaps in the data stream. PHY interface 32 encodes data stream 82 to generate a sequence 88 of encoded data blocks 90. In this example, block parser (FIG. 2) divides the data from stream 82 into data blocks 90 without regard to the boundaries between MPDUs, and each data block is encoded by block encoder 62 (FIG. 2) as a single codeword. In alternative embodiments, depending on the coding rate and codeword length, each encoded data block 90 comprises multiple codewords.

Modulator 78 converts encoded data blocks 90 into OFDM symbols 92, which are framed in PPDU 24, for output to analog & RF modules 80. In the pictured embodiment, encoding metadata 95, including block indexes 96 and lengths 97, are inserted in signaling field 44 in a preamble 94 of PPDU 24. Alternatively or additionally, some or all of the encoding metadata are inserted in headers of encoded data blocks 90. In these examples, it is assumed that modulator 78 generates multiple streams on multiple OFDM tones at a high-order modulation, such as 1024QAM; and each OFDM symbol 92 therefore extends over multiple data blocks, without regard to boundaries between the data blocks. Alternatively, at lower modulation rates (for example, using binary phase shift keying—BPSK), with lower bandwidth and fewer streams, each OFDM symbol 92 may cover only a part of an encoded data block.

As noted earlier, PHY interface 32 may signal the lengths of data blocks 90 in any of a variety of ways, as long as they enable PHY interface 50 (FIG. 1) at the receiving end to identifying the block boundaries in the received PPDU 24. For example, the block lengths may be represented in terms of bits, bytes, symbols (constellation symbols or OFDM symbols), time units (such as microseconds or seconds), or encoded units (such as codewords).

PHY interface 32 may also signal other encoding metadata 98 in PPDU 24, depending on the type of encoding that is used. For example, when FEC encoder 70 (FIG. 2) applies BCC encoding, a Viterbi decoder used in the FEC decoder in PHY interface 50 will need to know the modulation and coding scheme (MCS), as well as the number of bits (uncoded or coded) in each block. For LDPC encoding, the decoder will need to know both the number of uncoded bits and the number of available coded bits in each data block 90, along with the MCS of the block. The decoder can then derive the codeword length from the other parameters, using the coding rate of the MCS.

Alternatively, the encoding metadata may include the codeword length explicitly. In LDPC encoding, it is convenient that each data block contain an integer number of codewords, so that each block will start from a new codeword. The codeword length may be fixed across all blocks in PPDU 24, or it may vary from block to block (with appropriate signaling of the codeword length per block in the PPDU).

FIG. 4 is a block diagram that schematically illustrates receive-side circuitry in PHY interface 50, in accordance with an embodiment of the invention. PHY interface 50 comprises a pipeline of the following modules:
Analog & RF modules 100 (typically embodied in transceivers 52) convert the analog RF signals received from antennas 54 into a digital signal.
A demodulator 102 (which may include multiple demodulation modules, for example one per spatial stream) demodulates the received spatial streams and computes soft-bits (soft-decoding metrics) for the received data.
De-interleavers 104 (typically one per spatial stream) de-interleave the demodulated soft-bits of the received spatial streams, reversing the interleaving performed in the transmitter.
A stream deparser 106 deparses the spatial streams, so as to produce a single composite stream of soft-bits representing the encoded data. In the pictured implementation, the stream deparser also extracts signaling data from each PPDU 24, including the encoding metadata described above, such as the block indexes and lengths, as well as other encoding parameters.
A block deparser 108 uses the signaled block lengths in identifying block boundaries and thus dividing the encoded data into blocks for decoding.
Each block is passed to a respective block decoder 110, in which a FEC decoder 112 decodes the soft-bits in each codeword in order to recover the original data bits. The decoding process uses the block lengths and MCS indicated by the encoding metadata. For example, in LDPC decoding, FEC decoder 112 uses the encoding metadata to find the encoded codeword size; whereas in BCC decoding, the encoding metadata indicates to FEC decoder 112 where to stop and consider a tail bit convergence. When multiple copies of a given block have been received (as indicated by the block indexes), FEC decoder 112 combines the soft-bits from the multiple copies to improve the confidence of decoding on the basis of transmission diversity. In this case, the metadata indicate, either implicitly (in terms of block boundaries) or explicitly, the exact bits that were repeated. This indication is useful because some bits may be punctured or not repeated for other reasons. The receiver can then combine the soft decision metrics of the bits that were repeated. After FEC decoding, a descrambler 114 restores the original bit sequence by bit-wise multiplication with the scrambling sequence used by scrambler 68.

Block decoders 110 output the decoded data stream to MAC interface 48.

When block decoder 110 is unable to decode a given block, for example because it contained too many bit errors, PHY interface 50 may use the block index in an ARQ request to PHY interface 32 of AP 22. The block index identifies the block to be retransmitted at the PHY layer (and thus avoids having to refer to the MAC layer to identify the MPDU inn error). This feature enhances the efficiency of the retransmission function, since it enables AP 22 to retransmit only a small portion of the MPDU, rather than the entire MPDU when MAC-layer retransmission is used.

It is noted that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for data transmission in a wireless local area network (WLAN), the method comprising:
receiving, in a physical layer (PHY) interface of a first node in the WLAN, data for transmission over the WLAN;
dividing the received data in the PHY interface into a sequence of data blocks having respective lengths, and encoding the data blocks using an error correcting code (ECC);
encapsulating the encoded data blocks in a PHY protocol data unit (PPDU) together with encoding metadata including at least an indication of the respective lengths of the data blocks; and
transmitting the PPDU over the WLAN from the first node to a second node in the WLAN.

2. The method according to claim 1, wherein encapsulating the encoded data blocks comprises incorporating the encoding metadata in a preamble of the PPDU.

3. The method according to claim 1, wherein encapsulating the encoded data blocks comprises attaching respective block headers containing the encoding metadata to the data blocks in the PPDU.

4. The method according to claim 1, wherein the indication of the respective lengths comprises a number of data units selected from a group of data units consisting of a bits, bytes, symbols, time units, and codewords.

5. The method according to claim 1, wherein the encoding metadata further include one or more encoding parameters, selected from a group of parameters consisting of a coding rate and a codeword length.

6. The method according to claim 1, and comprising receiving in the PHY interface from the second node an automatic retransmission request (ARQ) over the WLAN to retransmit one of the encoded data blocks, and retransmitting the one of the encoded data blocks from the PHY interface using the encoding metadata.

7. The method according to claim 1, wherein transmitting the PPDU comprises transmitting the encoded data blocks together with the encoding metadata from the first node to the second node over two different frequency channels in the WLAN.

8. A method for data reception in a wireless local area network (WLAN), the method comprising:
receiving over the WLAN, in a physical layer (PHY) interface of a second node in the WLAN, a PHY protocol data unit (PPDU) transmitted by a first node in the WLAN, the PPDU including a sequence of data blocks, which have respective lengths, and are encoded using an error correcting code (ECC), together with encoding metadata including at least an indication of the respective lengths of the data blocks; and
decoding the data blocks in a second PHY interface of the second node to recover the data using the encoding metadata.

9. The method according to claim 8, wherein decoding the data blocks comprises detecting at the second node that the PHY interface is unable to decode one of the encoded data blocks in the PPDU using the ECC, and transmitting an automatic retransmission request (ARQ) from the PHY interface to the first node over the WLAN to retransmit the one of the encoded data blocks using the encoding metadata.

10. The method according to claim 8, wherein receiving the PPDU comprises receiving the encoded data blocks together with the encoding metadata from the first node at the second node over two different frequency channels in the WLAN, and wherein decoding the data blocks comprises jointly decoding the encoded data blocks received from the two different frequency channels using the encoding metadata.

11. Apparatus for data transmission in a wireless local area network (WLAN), the apparatus comprising:
a medium access control (MAC) interface, which is configured to generate frames of data for transmission over the WLAN; and
a physical layer (PHY) interface coupled to receive the data from the MAC interface and configured to divide the received data into a sequence of data blocks having respective lengths, encode the data blocks using an error correcting code (ECC), encapsulate the encoded data blocks in a PHY protocol data unit (PPDU) together with encoding metadata including at least an indication of the respective lengths of the data blocks, and transmit the PPDU over the WLAN to a receiving node in the WLAN.

12. The apparatus for data transmission according to claim 11, wherein the PHY interface is configured to incorporate the encoding metadata in a preamble of the PPDU.

13. The apparatus for data transmission according to claim 11, wherein the PHY interface is configured to attach respective block headers containing the encoding metadata to the data blocks in the PPDU.

14. The apparatus for data transmission according to claim 11, wherein the indication of the respective lengths comprises a number of data units selected from a group of data units consisting of a bits, bytes, symbols, time units, and codewords.

15. The apparatus for data transmission according to claim 11, wherein the encoding metadata further include one or more encoding parameters, selected from a group of parameters consisting of a coding rate and a codeword length.

16. The apparatus for data transmission according to claim 11, wherein the PHY interface is configured to receive from the receiving node an automatic retransmission request (ARQ) over the WLAN to retransmit one of the encoded data blocks, and retransmitting the one of the encoded data blocks using the encoding metadata.

17. The apparatus for data transmission according to claim 11, wherein the PHY interface is configured to transmit the encoded data blocks together with the encoding metadata to the receiving node over two different frequency channels in the WLAN.

18. A WLAN system comprising:
the apparatus for data transmission, comprising a first MAC interface and a first PHY interface according to claim 11; and
the receiving node, which comprises a second PHY interface configured to receive the PPDU over the WLAN from the transmitting node and to decode the data blocks using the encoding metadata to recover the data.

19. The system according to claim 18, wherein the second PHY interface is configured, upon detecting that the second PHY interface is unable to decode one of the encoded data blocks in the PPDU using the ECC, to transmit over the WLAN an automatic retransmission request (ARQ) to the first PHY interface to retransmit the one of the encoded data blocks using the encoding metadata.

20. The system according to claim 18, wherein the first PHY interface is configured to transmit the encoded data blocks together with the encoding metadata from the transmitting node to the receiving node over two different frequency channels in the WLAN, and wherein the second PHY interface is configured to jointly decode the encoded data blocks received from the two different frequency channels using the encoding metadata.
